(19) United States
(12) Patent Application Publication
(10) Pub. No.: US 2021/0138875 A1
(43) Pub. Date: May 13, 2021

(54) PORTABLE GOLF CART FAN

(71) Applicant: Les Oyler, Harrisburg, IL (US)

(72) Inventor: Les Oyler, Harrisburg, IL (US)

(21) Appl. No.: 17/077,952

(22) Filed: Oct. 22, 2020

Related U.S. Application Data
(60) Provisional application No. 62/927,940, filed on Oct. 30, 2019.

(51) Int. Cl. B60H 1/24; B60H 1/00; F04D 25/06; F04D 25/16

(52) U.S. Cl. CPC B60H 1/244; B60H 1/00407; B60H 1/0025; F04D 25/166; F04D 25/0673

(57) ABSTRACT

A fan to be mounted behind a golf cart passenger's head and powered by the golf cart's battery in order to provide a cooling system for the passengers. The fans are combined by two channel steel beams running the length of the device. The fans have power cords that are intended to be attached to the cart's battery, providing a power source. It is intended for the fan to be secured to the cart's rear stanchions to hold it in place during cart operation by bungee cords or any other suitable device. The beams can extend horizontally to accommodate any space between the rear roof stanchions on a variety of golf carts. The fan is portable and can easily be attached and taken off the cart without issue while still maintaining stability during the cart's operation.

### CROSS REFERENCE TO RELATED APPLICATIONS

The present application claims the benefit of U.S. Provisional Application No. 62/927,940, filed Oct. 30, 2019, entitled “Portable Golf Cart Fan,” which is hereby incorporated by reference.

### BACKGROUND OF THE INVENTION

This invention relates to fans, specifically to a fan mounted behind the driver and passenger on a golf cart.

Golf is a game commonly played in the summertime around the world, primarily in North America. These summer days often get very hot, especially on an open golf course that offers no shade. With golfers spending many hours outside under the sun, they are prone to overheating and need an efficient and easy-to-use way of staying cool.

This invention addresses the common problem of playing golf in the sweltering summer heat. Playing golf in the summer in certain areas of the world often has the risk of the players overheating, causing discomfort or even heat stroke. Golfers often want a way to cool off in between shots and the traditional ways of doing it have limitations. A hand-held fan is too small and does not have enough power while also being tedious to carry around. Mounting a fan on the dashboard of a golf cart only allows for one rider to be cooled at a time and can also block the field of view of the driver. Many current fans also have trouble connecting to the cart's battery as they are too far away from it for easy connection. Using a hand towel only gets rid of sweat and carrying around a bucket of ice-cold water in a golf cart will not retain its temperature for very long.

As shown, there are many issues with current treatments for the summer heat while golfing. It remains clear that a solution is needed that is convenient to use, can affect multiple people simultaneously, and will not interfere with a driver's field of view or ability to drive the golf cart. The solution must also be close to the cart battery for easy installment and be portable since many golfers do not own their own golf carts, therefore making permanent modifications to a rented golf cart unsatisfactory.

### BRIEF DESCRIPTION OF THE INVENTION

This invention is made of two electric, bladed fans that can be tilted up or down to adjust air direction and are mounted on the rear of a golf cart behind the occupant's heads. Specifically, the invention is to be secured to the two rear roof support stanchions of the cart using bungee cords or other safe and applicable straps or fasteners. Side braces are extended from the fan and locked in place to match any space between the roof support stanchions on a variety of golf carts. After being secured, the fan should often hover about one inch above the cart seats but may be set higher depending on the height of the occupants. The fans are intended to provide a cooling breeze to both cart occupant's head and neck area. The fans have a power cord extending from them ending in alligator clips, typically one red clip for positive and one black clip for negative, that connect to the golf cart's battery or batteries, powering the fans without the use of an additional external battery or other form of electricity. The alligator clips provide a simple installment procedure without any extraneous tools needed. Connecting the fans to the cart's battery allows for the invention to always be used when the golf cart is being operated without risk of the fan's own battery failing or other external circumstances, such as failing to replace the fan's batteries. The fan runs on 12-volts, matching the common 12-volt golf cart battery. This allows for simple operation as all it takes is to clip the power cords to the battery. In the case that the golf cart operates on a 36-volt or 48-volt, the fan can still be powered by connecting the alligator clips to specific positive and negative terminals of the battery series.

The invention is also completely portable, allowing the fan to be easily removed quickly when the golf outing is finished or when the fan is no longer needed. This synergizes with the common issue of golfers often not owning their own golf cart. The portability allows for this invention to be of proper use without making any permanent modifications to the golf cart. The invention is also lightweight, allowing for easy transportation from home to cart.

### BRIEF DESCRIPTION OF THE DRAWINGS

FIG. 1 is a front-view perspective of the invention in its intended position.

FIG. 2 is a back-view perspective of the invention in its intended position.

FIG. 3 is a front-view perspective of the invention isolated from any third-party objects.

FIG. 4 is a profile view of the cart with the fan installed and an example battery shown.

FIG. 5 is a picture of a typical cart battery with the power cords attached.

### DETAILED DESCRIPTION OF THE INVENTION

The invention, as best seen in FIG. 3, is comprised of a conventional bladed fan 2a and 2b covered in a wire protector 8a and 8b, with the fan's motor and electrical components contained in a casing 6a and 6b, surrounding the fan 2 and wire protector 8. One embodiment of the invention, the embodiment shown in FIGS. 1, 2, and 3, has the fan casing dimensions made at 12×12.50 inches. There is a total of two fans, as previously described, linked together by two slotted channel steel beams 4a and 4b, running the length of the entire invention, one on both the top and bottom of the fans which could be made longer or shorter depending on the specific requirements of each individual cart. Each fan includes a fan housing that surrounds the fan and attaches to the beams. The slotted steel channel may be replaced with other materials in different embodiments of the invention as long as it safely and securely links the two fans together, such as aluminum or plastic. In an alternate embodiment, the slotted steel channel beams may be smooth or there may be more than two beams. In another embodiment, there may be any number of fans appropriate for the length of beams.

As best seen in FIG. 4, the invention is to be mounted behind and above the vehicle's seats 10, behind the driver and potential passenger's heads, hovering approximately an inch or more above the seats. The invention may be mounted in a position appropriate to direct the airflow produced by a fan onto the neck and head of a passenger. The neck is an area effective in cooling a person's core temperature. In an alternate embodiment, the airflow may be directed elsewhere on a passenger's body that may assist in cooling the passenger's core temperature. In one embodiment, each fan housing and fan, or fan alone, may be capable of tilting about a horizontal axis to redirect the airflow as desired.

As seen in FIG. 2, the invention is to be mounted to a cart through rear roof support stanchions that hold up the roof of the cart 12a and 12b in conjunction with bungee cords 14a and 14b or any other device the user would find suitable. Air flow direction from each fan can be independently tilted up or down as needed around each fan's horizontal axes. Each fan also has multiple speed settings that are adjusted independently.

The power cord comes out of casing 6a or 6b and end with alligator clips 18 and 20, intended to be connected to the cart's battery 16, often located behind, to the side, or under the seat of the driver. There are two alligator clips, typically one red clip 18 for the positive terminal 22 and one black clip 20 for the negative terminal 24. Any suitable power device could be used in place of the provided alligator clips in different embodiments of the invention. The clips are intended to be attached to the positive terminal 22 and negative terminal 24 of the battery.

This invention allows the riders to have an individual cooling system. One for the driver and one for the passenger that is powered by the cart's battery while also requiring no additional operation that could potentially distract a cart driver during cart operation.

The invention is to be mounted behind and above the vehicle's seats 10, fastened onto rear roof support stanchions 12a and 12b or any appropriate alternative, along with bungee cords 14a and 14b or any appropriate alternative. The slotted steel channel beams 4a and 4b extend outwards towards the stanchions 12a and 12b to accommodate any required space. In one embodiment, the invention may be removably attached to the golf cart, allowing the invention to be easily installed, uninstalled, and transported between multiple golf carts. In an alternate embodiment, the invention may be permanently secured to the golf cart.

The power cord extending from the fans' casing 6a or 6b are to be attached to the vehicle's battery 16 at the positive terminal 22 and the negative terminal 24 to the appropriate number of batteries in accordance with the voltage level of each battery and the voltage requirement of the fans. The cart battery system may include a 6-volt battery, 8-volt battery, or a 12-volt battery. In some embodiments, the cart battery system may be multiple batteries connected in series. Some cart battery systems may include a series of batteries with a total voltage of 36 or 48 volts.

For an electric cart, a series of lower voltage batteries are linked together to create a larger voltage. 36-volt electric carts are comprised of six 6-volt batteries connected in a series and 48-volt electric carts are comprised of four 12-volt batteries. In the case of the cart having a 36-volt motor, the black negative alligator clip 20 is to be attached to the negative terminal 24 of the first 6-volt battery of the series while the red positive alligator clip 18 is to be attached to the positive terminal 22 of the second 6-volt battery in the series. This connects the fan to 12-volts by taking power from only the first two serialized 6-volt batteries. Likewise, in the case of the cart having a 48-volt motor, the black negative alligator clip 20 is to be attached to the negative terminal 24 of the first 12-volt battery in the series while the red positive alligator clip 18 is to be attached to the positive terminal 22 of the first 12-volt battery in the series. This gives the fan a 12-volt charge by only taking power from the first serialized 12-volt battery.

The invention may be configured to preserve battery capacity. In some embodiments this may include only drawing power when the fan is operating to prevent additional discharge from the golf cart batteries when the fan is not in operation. In another embodiment the invention may be configured to automatically shut off after a predetermined period of time to conserve power. In yet another embodiment the invention may be configured to draw the minimal power necessary to operate the fan.

Alternative embodiments of the invention may contain bladeless fans to avoid any possibility of the riders' hair being blown back into the fan by a gust of wind, catching the hair in the blades. Using bladeless fans prevents this issue. In another embodiment, there may be a screen to prevent objects from getting caught in the fan, such as long hair. The screen may be attached to the fan casing; therefore, each fan has a screen attached. Alternatively, the screen may be mounted to the beams, wherein the size of the screen is sufficient to cover each fan attached to the beams. There may be at least one screen on the passenger-facing side of the fan, in another embodiment there may also be a screen on a rear-facing side of the fan.

Furthermore, the fans may be configured to automatically turn off if something gets caught in a fan. One or more fans may include a sensor that detects if an object interferes with the fan or enters the fan housing. Upon detecting an object, the connection between the battery and the fan may be interrupted, resulting in the fan losing power. In an alternate embodiment, upon detecting an object a brake may trigger to stop the motion of the fan blades, preventing injury and damage.

The examples described herein are merely illustrative and are not meant to be an exhaustive list of all possible embodiments, applications or modifications of the invention. Various modifications and variations of the described methods and systems of the invention will be apparent to those skilled in the art without departing from the scope and spirit of the invention. Although the invention has been described with respect to particular embodiments, it will be understood that the invention as claimed should not be unduly limited to such specific embodiments. Various modifications of the described modes for carrying out the invention which are obvious to those of ordinary skill in the art are intended to be within the scope of the appended claims.

What is claimed is:

1) A golf cart fan assembly comprising:
a) a golf cart battery, wherein the battery includes a positive terminal and a negative terminal, wherein the golf cart battery supplies power to a golf cart;
b) a fan housing, wherein the fan housing includes a top support and a bottom support, wherein the top support is secured to both a first stanchion on golf cart and a second stanchion on a golf cart, wherein the bottom support is secured to both the first stanchion on a golf cart and the second stanchion on a golf cart; and
c) at least one fan, wherein the fan is secured to the fan housing, wherein the fan includes a power cord, wherein the power cord is secured to the positive terminal and the negative terminal coupling the fan and the golf cart battery.

2) The golf cart fan assembly of claim 1, wherein the first stanchion is a first rear stanchion, wherein the second stanchion is a second rear stanchion.

3) The golf cart fan assembly of claim 1, further comprising two fans mounted in a horizontal plane, wherein the fans are secured to the fan housing.

4) The golf cart fan assembly of claim 1, further comprising a second fan coupled to the fan housing.

5) The golf cart fan assembly of claim 1, further comprising a second fan housing, the second fan housing having a second fan coupled thereto.

6) The golf cart fan assembly of claim 1, wherein the fan housing comprises a fan guard, wherein the fan guard is a physical barrier for the fan and configured to allow airflow.

7) The golf cart assembly of claim 1, wherein the fan includes a tilting mechanism, wherein the tilting mechanism tilts the fan around a horizontal axis.

8) The golf cart assembly of claim 1, wherein the fan includes a plurality of fan blades.

9) The golf cart assembly of claim 8, wherein the fan includes a shut-off mechanism, wherein the shut-off mechanism prevents rotation of the plurality of fan blades when hair is caught in the fan.

10) The golf cart assembly of claim 1, wherein the fan is a bladeless fan.

11) The golf cart assembly of claim 1, wherein the battery is a 12-volt battery.

12) The golf cart assembly of claim 1, wherein the battery is a 6-volt battery.

13) The golf cart assembly of claim 1, wherein the battery comprises a first 6-volt battery and a second 6-volt battery connected in series, wherein the power cord is secured to the positive terminal of the first 6-volt battery and the negative terminal of the second 6-volt battery.
